(19) United States
(12) Patent Application Publication
(10) Pub. No.: US 2012/0183465 A1
(43) Pub. Date: Jul. 19, 2012

(54) PLANT AND PROCESS FOR PREPARING MONOSILANE

(75) Inventors: Adolf Petrik, Freudenstadt (DE); Jochem Hahn, Rottenburg (DE); Christian Schmid, Freudenstadt (DE)

(73) Assignee: SCHMID SILICON TECHNOLOGY GMBH, Freudenstadt (DE)

(21) Appl. No.: 13/388,681

(22) PCT Filed: Aug. 2, 2010
(86) PCT No.: PCT/EP2010/061199

§ 371 Date: Apr. 3, 2012

(30) Foreign Application Priority Data
Aug. 4, 2009 (DE) 10 2009 037 154.0

(51) Int. Cl. C01B 33/107; B01J 19/00

(52) U.S. Cl. 423/342; 422/187

(57) ABSTRACT

A plant and a process prepare monosilane (SiH₄) by catalytically disproportionating trichlorosilane (SiHCl₃). The trichlorosilane is converted in a reaction column over a catalyst and then purified in a rectification column. Between a reactive/distillative reaction region in the reaction column and the rectification column are arranged one or more condensers in which monosilane-containing reaction product from the reaction column is partly condensed. However, these are exclusively condensers which are operated at a temperature above −40° C.

### RELATED APPLICATIONS

This is a §371 of International Application No. PCT/EP2010/061199, with an international filing date of Aug. 2, 2010 (WO 2011/015548 A1, published Feb. 10, 2011), which is based on German Patent Application No. 10 2009 037 154.0, filed Aug. 4, 2009, the subject matter of which is incorporated by reference.

### TECHNICAL FIELD

This disclosure relates to a plant for preparing monosilane (SiH₄) by catalytically disproportionating trichlorosilane (SiHCl₃), and to a corresponding process which can be performed in such a plant.

### BACKGROUND

High-purity silicon is generally prepared in a multistage process proceeding from metallurgical silicon which can have a relatively high proportion of impurities. To purify the metallurgical silicon, it can be converted, for example, to a trihalosilane such as trichlorosilane (SiHCl₃) which is subsequently decomposed thermally to give high-purity silicon. Such a procedure is known, for example, from DE 2 919 086. Alternatively, high-purity silicon can also be obtained by thermal decomposition of monosilane, as described, for example, in DE 33 11 650.

Monosilane can be obtained especially by disproportionation of trichlorosilane. The latter in turn is preparable, for example, by reaction of metallurgical silicon with silicon tetrachloride and hydrogen.

DE 198 60 146, among others, discloses allowing disproportionation of trichlorosilane to proceed by the principle of reactive distillation. Reactive distillation is characterized by a combination of reaction and distillative separation in an apparatus, especially in a column. In this apparatus, the lowest-boiling component in each case is continuously removed by distillation, while always attempting to maintain, in each spatial element of the apparatus, an optimal gradient between equilibrium state and actual content of lower-boiling components or lowest-boiling component. Particular preference is given to performing disproportionation of trichlorosilane to silicon tetrachloride and monosilane in a column which has reactive/distillative reaction regions filled at least partly with catalytically active solids. Suitable solids are described, for example, in DE 33 11 650.

EP 1 268 343 discloses performing disproportionation of trichlorosilane in at least two reactive/distillative reaction regions comprising catalytically active solid. This involves intermediate condensation of the monosilane-containing product mixture obtained in a first reactive/distillative reaction region in an intermediate condenser at a temperature between minus 40° C. and 50° C. The uncondensed product mixture is transferred into at least one further reactive/distillative reaction region. Connected downstream thereof in turn is a top condenser which may in turn be followed by a separating column. This top condenser is operated at temperatures below minus 40° C., usually below minus 60° C.

An analogous procedure is also known from EP 1 144 307. It is stated here that monosilane-containing product mixture obtained in disproportionation of trichlorosilane is intermediately condensed at a temperature between minus 25° C. and 50° C., and the uncondensed product mixture is subsequently condensed fully in the top condenser of a reaction column. In this case too, a further separate separating column may be connected downstream of the top condenser.

The downstream separating column as mentioned in EP 144 307 and EP 1 268 343 is especially a rectification column. The use of such a column is generally required when purity of the monosilane to be obtained is of particularly high significance. To avoid burdening a downstream rectification column too greatly with impurities such as chlorosilanes, it has always been considered to be necessary in the past to remove them to a very substantial degree by the intermediate and top condensers mentioned. However, this was associated with quite a high apparatus complexity and energy expenditure.

It could therefore be helpful to provide a technical solution for preparation of monosilane of ultrahigh purity which is very simple in apparatus terms while having a high energy efficiency.

### SUMMARY

We provide a plant for preparing monosilane by catalytically dispropotionating trichlorosilane including a reaction column including a reactive/distillative reaction region in which the trichlorosilane is converted over a catalyst, and an outlet for monosilane-containing reaction product, a rectification column in which the monosilane-containing reaction product is purified, and between the reactive/distillative reaction region in the reaction column and the rectification column, one or more condensers in which the monosilane-containing reaction product is partly condensed before subsequent purification in the rectification column, wherein none of the condensers arranged between the reactive/distillative reaction region and the rectification column has an operating temperature below minus 40° C.

We also provide a process for preparing monosilane (SiH₄) by catalytically disproportionating trichlorosilane (SiHCl₃) in the plant, wherein the trichlorosilane is converted in a reaction column with a reactive/distillative reaction region to form a monosilane-containing reaction product which is subsequently purified in a rectification column, wherein the monosilane-containing reaction product, before being transferred into the rectification column, is partly condensed in at least one condenser, but does not pass through a condenser which is operated at a temperature below −40° C.

### BRIEF DESCRIPTION OF THE DRAWING

FIG. 1 shows a schematic diagram of the structure of our plant including a reaction column, a rectification column and a condenser connected upstream of the rectification column.

### DETAILED DESCRIPTION

Our plant for preparing monosilane has, analogously to the plants described in EP 1 268 343 and EP 1 144 307, a reaction column with a reactive/distillative reaction region in which trichlorosilane can be disproportionated over a catalyst. The reaction column comprises an outlet for monosilane-containing reaction product formed in the disproportionation. This reaction product is subsequently purified in a rectification column which is likewise part of our plant.

Between the reactive/distillative reaction region of the reaction column and the rectification column, our plant comprises one or more condensers in which the monosilane-containing reaction product is partly condensed before the subsequent purification in the rectification column.

Our plant is particularly notable in that none of the condensers arranged between the reactive/distillative reaction region of the reaction column and the rectification column is a condenser which has an operating temperature below minus 40° C.

Instead, the operating temperature of the condenser(s) between the reactive/distillative reaction region and the rectification column is preferably between minus 20° C. and minus 40° C. Within this region, values between minus 20° C. and minus 30° C. are more preferred. Most preferably, the operating temperature is approx. minus 25° C.

The condenser(s) between the reaction column and the rectification column are thus preferably filled with a coolant having a temperature above minus 40° C., preferably between minus 20° C. and minus 40° C., especially between minus 20° C. and minus 30° C., more preferably of approx. minus 25° C. Suitable coolants for these temperature ranges are known.

The condenser(s) may be integrated, for example, within the top of the reaction column. It is, however, also possible to connect one or more separate condensers between the reaction column and the rectification column.

In this connection, our plant may have more than one reaction column and/or more than one rectification column. For example, it is possible without difficulty to connect a plurality of reaction and rectification columns in parallel to increase conversion of the plant. The same also applies in turn to the condensers arranged between the rectification columns and the reaction columns.

As a result of the relatively low temperatures at which the condenser(s) arranged between the rectification column and reaction column are operated, it is also possible that chlorosilanes, especially monochlorosilane, will pass through them. The result is that the monosilane-containing product mixture entering the rectification column will generally have a significant proportion of chlorosilanes, especially of monochlorosilane.

The rectification column preferably has a heating region in which entering monosilane-containing or monochlorosilane-containing reaction product from the reaction column can be evaporated completely. Preferably, this heating region is set to a temperature between 0° C. and 20° C. At these temperatures, only silicon tetrachloride or trichlorosilane would not be evaporated. However, these two components generally pass through the upstream condensers only in very small amounts, if at all.

The rectification column preferably comprises a cooling region which directly follows the heating region of the rectification column. Within this cooling region, the temperature declines gradually proceeding from the heating region of the rectification column. It is preferred that the temperature declines down to values between −80° C. and −100° C., preferably to approx. −90° C. The pressure in the cooled region of the rectification column is preferably between 1 bar and 5 bar, especially between 2 and 3 bar. At such temperatures, all chlorosilanes are generally completely removable such that essentially pure monosilane leaves the rectification column. For the purpose of further storage, this can subsequently be condensed completely, but if appropriate can also be processed further immediately or sent to a further purification. However, such a further purification is required only when ultrahigh demands are being made on the purity of the monosilane. It has been found that, surprisingly, it is also quite possible only with one rectification column to prepare monosilane in high purity, especially when complying with the preferred reaction conditions for the reaction and rectification columns mentioned above and below, even without upstream condensers for removing chlorosilanes with operating temperatures below minus 40° C.

Dispensing with such condensers gives rise to various advantages. First, the plant can be kept comparatively simple in apparatus terms. It is much less complicated to design a condenser for operation at minus 25° C. than for operation below minus 60° C., as is typical. Different, cheaper coolants can be used, low-temperature refrigerators are not required, and the isolation expenditure is lower. Furthermore, compared to many known plants, significant energy advantages arise, especially compared to those plants in which total condensation of the monosilane-containing product mixture which arrives at the top of the reaction column is envisaged. Since a downstream purification in a rectification column cannot be avoided even in such cases, and the condensed monosilane-containing product would have to be evaporated again in any case. Therefore, it is undoubtedly more appropriate to dispense with a total condensation.

Preferably, the rectification column is connected to the reaction column via a recycle line such that chlorosilanes condensed and removed in the rectification column can be returned to the reaction column.

The reactive/distillative reaction region of a reaction column may preferably be formed from two or more separate reactive/distillative individual regions. These may be arranged in series and/or in parallel to one another. More preferably, two or more reactive/distillative individual regions are arranged one on top of another in a reaction column, in which case upper reaction regions are preferably operated at lower temperatures than lower reaction regions.

Preferably, our plant comprises at least one intermediate condenser arranged between two such individual regions. Such an intermediate condenser may be operated, for example, at temperatures between −20° C. and +30° C., preferably between 0° C. and 25° C. For example, operation with cooling water at room temperature is possible.

The temperature in the reactive/distillative reaction region is generally set to values between 10° C. and 200° C., especially between 10° C. and 150° C. The pressure in the reaction column is preferably between 1 bar and 5 bar, especially between 2 bar and 3 bar. The temperature set in individual reaction regions may quite possibly differ significantly.

As already mentioned above, we also provide a process for preparing monosilane. More particularly, the process can also be performed efficiently in our plant.

In the process, trichlorosilane is converted in a reaction column with a reactive/distillative reaction region to form a monosilane-containing reaction product. The latter is subsequently purified in a rectification column, wherein the monosilane-containing reaction product, before being transferred into the rectification column, is partly condensed in at least one condenser, but does not pass through a condenser which is operated at a temperature below minus 40° C.

The operating parameters of the reaction column, of the rectification column and of the intermediate condensers, and the most important other features thereof, have already been discussed above. Hence, reference is made to the corresponding remarks to avoid repetition.

Further features are evident from the description of preferred examples which follows. It is possible for individual features, in each case alone or several in combination with one another, to be implemented in one example. The preferred examples described serve merely for illustration and for better understanding and should in no way be interpreted in a restrictive manner.

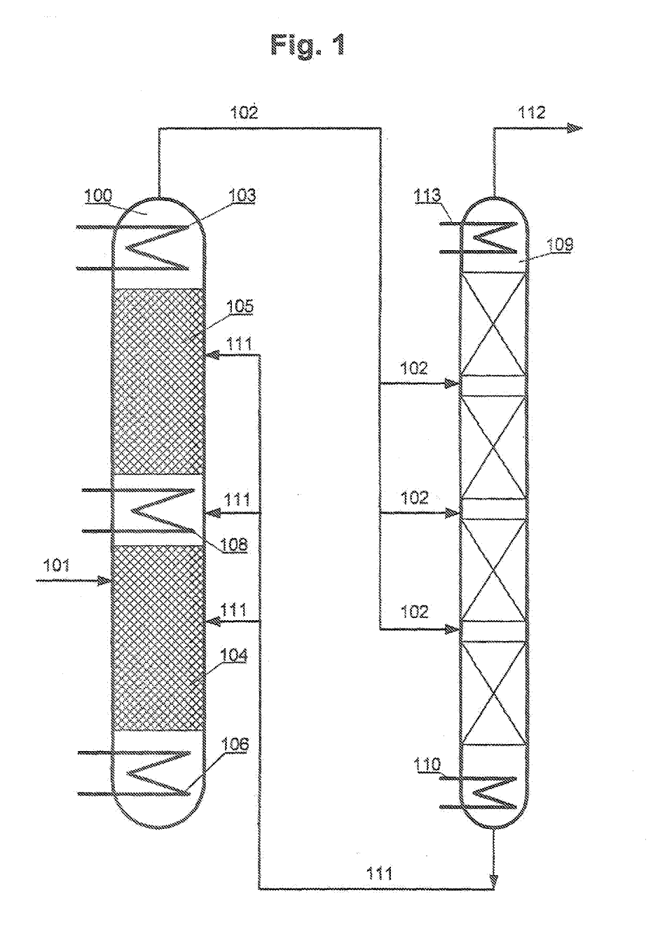

FIG. 1 shows the reaction column 100 in which trichlorosilane can be converted under disproportionating conditions. Trichlorosilane can be supplied via the inlet 101. The reaction column has a heating region 106 in which energy required to evaporate the trichlorosilane is provided. The actual conversion proceeds in the reactive/distillative individual regions 104 and 105, which together form the reactive/distillative reaction region of the reaction column 100. Catalytically active solids are present in each of the two individual regions. Trichlorosilane introduced into the column via the inlet 101 is thus converted in a first step in the individual region 104, which forms a monosilane-containing product mixture which can escape into the individual region 105. Conversely, disproportionation products with greater density and higher boiling point such as tetrachlorosilane descend downwardly. In the individual region 105, a second, further disproportionation may proceed in which case the proportion of monosilane in the converted reaction mixture further increases. Finally, the monosilane-containing reaction mixture can be transferred via the outlet 102 into the rectification column 109 in which a further separation of the reaction mixture may proceed.

Between the rectification column 109 and the individual region 105, or the reactive/distillative reaction region of the reaction column 100, is arranged the condenser 103 which is integrated into the top of the reaction column 100 and operated at a temperature of minus 25° C. In addition, the reaction column comprises the intermediate condenser 108 which is arranged between the individual regions 104 and 105 and operated at a temperature of approx. 20° C.

Monosilane-containing product mixture entering the rectification column 109 can be evaporated in the heating region 110 which is operated at a temperature of approx. 0° C. In the downstream cooling region of the rectification column, a further separation proceeds. Condensed chlorosilanes can be removed via the line 111. In this case, this is connected to the reaction column 100 such that the condensed chlorosilanes can be returned thereto. At the top of the rectification column, a temperature of approx. minus 90° C. is set. It is possible here for essentially only monosilane to pass through which is sent to the further use thereof via the outlet 112.

1. A plant for preparing monosilane by catalytically disproportionating trichlorosilane comprising:
a reaction, column comprising a reactive/distillative reaction region in which the trichlorosilane is converted over a catalyst, and an outlet; for monosilane-containing reaction product,
a rectification column in which the monosilane-containing reaction product is purified, and
between the reactive/distillative reaction region in the reaction column and the rectification column, one or more condensers in which the monosilane-containing reaction product is partly condensed before subsequent purification the rectification column,
wherein none of the condensers arranged between the reactive/distillative reaction region and the rectification column has an operating temperature below minus 40° C.

2. The plant according to claim 1, wherein the operating temperature of the condenser(s) between the reactive/distillative reaction region and the rectification column is between minus 20° C. and minus 40° C.

3. The plant according to claim 1, wherein the condenser(s) is/are integrated into a top portion of the reaction column.

4. The plant according to claim 1, wherein the rectification column has a heating region in which entering monosilane-containing reaction product from the reaction column (100) can be completely evaporated completely.

5. The plant according to claim 4, wherein the heating region is set to a temperature between 0° C. and 20° C.

6. The plant according to claim 4, wherein the rectification column has a cooling region in which the temperature declines gradually proceeding from the heating region of the rectification column.

7. The plant according to claim 6, wherein the temperature within the rectification column declines down to between minus 80° C. and minus 100° C.

8. The plant according to claim, 1, wherein the rectification column connects to the reaction column via a recycle line such that chlorosilane-containing product condensed in the rectification column can be returned to the reaction column.

9. The plant according to claim 1, wherein the reactive/distillative reaction region is formed from two or more separate reactive/distillative individual regions arranged in series and/or parallel to one another.

10. The plant according to claim 9, comprising at least one intermediate condenser arranged between two of the individual regions.

11. The plant according to claim 10, wherein the at least one intermediate condenser is operated at a temperature between minus 20° C. and 30° C.

12. The plant according to claim 1, wherein the temperature in the reactive/distillative reaction region is between 50° C. and 200° C.

13. A process for preparing monosilane (SiH₄) by catalytically disproportionating trichlorosilane (SiHCl₃) in a plant according to claim 1, wherein the trichlorosilane is converted in a reaction column with a reactive/distillative reaction region to form a monosilane-containing reaction product which is subsequently purified in a rectification column, wherein the monosilane-containing reaction product, before being transferred into the rectification column, is partly condensed in at least one condenser, but does not pass through a condenser which is operated at a temperature below −40° C.
